(19) United States
(12) Patent Application Publication
(10) Pub. No.: US 2025/0040529 A1
(43) Pub. Date: Feb. 6, 2025

(54) FISHING DEVICE

(71) Applicant: GUANGDONG COROS SPORTS TECHNOLOGY CO., LTD, Dongguan (CN)

(72) Inventors: Haotian NIU, Dongguan (CN); Yu TANG, Dongguan (CN); Hongbo XU, Dongguan (CN)

(21) Appl. No.: 18/925,666

(22) Filed: Oct. 24, 2024

Related U.S. Application Data
(63) Continuation of application No. PCT/CN2022/091071, filed on May 6, 2022.

(51) Int. Cl. A01K 89/033

(52) U.S. Cl. CPC A01K 89/033

(57) ABSTRACT

An fishing device includes a fishing rod, a reel, a fishing line, a first detector, a second detector, and a control assembly. The reel is arranged at the fishing rod and includes a spool. The fishing line is wound around the spool and includes a plurality of detection marks arranged along an axial direction of the fishing line at intervals. The first detector is configured to detect the detection marks to obtain a line release speed of the fishing line. The second detector is configured to detect a rotation speed of the spool. The control assembly is configured to control a brake assembly to brake the spool according to the line release speed to cause the rotation speed of the spool to match the line release speed.

### CROSS-REFERENCE TO RELATED APPLICATION

The present application is a continuation of International Application No. PCT/CN2022/091071, filed May 6, 2022, the entire content of which is incorporated herein by reference.

### TECHNICAL FIELD

The present disclosure generally relates to the fishing device technology field and, more particularly, to a fishing device.

### BACKGROUND

A fishing rod includes a reel and a rod. The reel is fixed near the handle of the fishing rod. One end of a fishing line is wound around a spool of the reel, and the other end is connected to bait. When the bait at the end of the fishing line is cast, the fishing line is pulled out by the bait, and the spool is in a free rotation state before the bait falls into water. After the bait is cast, the speed gradually increases and reaches a maximum value before falling into water. After the bait falls into water, the speed reduces rapidly. Thus, the speed for pulling out the fishing line is correspondingly rapidly reduced. However, the spool is still in a high-speed free rotation state, and the speed is not correspondingly reduced. Thus, the speed of pulling out the fishing line from the spool is smaller than the rotation speed of the spool. Since the fishing line pulled out by the rotation of the spool is not able to be pulled away by the bait in time, the spool can rewind the fishing line reversely or the fishing line can become loose and twisted, which causes the spool to have a backlash.

To address the above issue, centrifugal braking or electromagnetic damping is generally used to apply a braking force to the spool for braking when the bait is cast. However, the above method cannot avoid the backlash of the reel and can affect the casting distance of the bait. Alternatively, the user can press the spool using their thumb according to the experience of the user, when the speed of the bait reduces rapidly, a braking force can be applied through the pressing of the thumb to brake the spool and avoid the backlash. However, the method highly depends on the experience of the user. For users unfamiliar with the fishing rod, the above operational method cannot be implemented.

### SUMMARY

In accordance with the disclosure, there is provided a fishing device including a fishing rod, a reel, a fishing line, a first detector, a second detector, and a control assembly. The reel is arranged at the fishing rod and includes a spool. The fishing line is wound around the spool and includes a plurality of detection marks arranged along an axial direction of the fishing line at intervals. The first detector is configured to detect the detection marks to obtain a line release speed of the fishing line. The second detector is configured to detect a rotation speed of the spool. The control assembly is configured to control a brake assembly to brake the spool according to the line release speed to cause the rotation speed of the spool to match the line release speed.

### BRIEF DESCRIPTION OF THE DRAWINGS

FIG. 1 is a schematic structural diagram of a fishing device according to some embodiments of the present disclosure.

FIG. 2 is a schematic structural diagram of a fishing device without a fishing line according to some embodiments of the present disclosure.

FIG. 3 is an enlarged view of part A in FIG. 1.

### REFERENCE NUMERALS

| | | | |
|---|---|---|---|
| 1 Fishing rod | 2 Fishing reel | 3 Spool | 22 Real frame |
| 23 First guide member | | 231 First guide hole | |
| 24 Second guide member | | 241 Second guide hole | |
| 3 Fishing line | 31 Detection mark | | |

### DETAILED DESCRIPTION OF THE EMBODIMENTS

The technical solution of the present disclosure is described in detail in connection with the accompanying drawings. The embodiments are merely used to describe the present disclosure. To facilitate description, the accompanying drawings only show parts related to the present disclosure but not necessarily all parts.

In some embodiments, the terms “connected,” “coupled,” and “fixed” should be broadly interpreted. For example, the connection can be a fixed connection, a detachable connection, or an integration; a mechanical connection or an electrical connection; or a direct connection, an indirect connection through an intermedium, or an internal communication or an interaction relationship of two elements intermediaries; or communication or interaction between two components. For those skilled in the art, the meanings of the terms of the present disclosure can be understood based on the above terms.

In the present disclosure, a first feature is “on” or “under” a second feature can include the first feature directly contacting the second feature, or the first feature not directly contacting the second feature but the first feature contacting the second feature through another feature. Moreover, the first feature being “on,” “above,” and “over” the second feature can include the first feature being right above and diagonally above the second feature, or merely a horizontal height of the first feature being higher than a horizontal height of the second feature. The first feature being “below,” “under,” and “lower than” the second feature can include the first feature is right under and diagonally under the second feature or the horizontal height of the first feature being smaller than the horizontal height of the second feature.

In the description of embodiments of the present disclosure, orientational or positional relationships described using the terms “up,” “bottom,” “right,” etc., are based on the orientation or position shown in the accompanying drawings to facilitate description and simplify operation, and do not imply or indicate that the device or element must have a certain orientation or is constructed or operated with a certain orientation. In addition, the terms “first” and “second” are merely used to distinguish in the description and do not have a special meaning.

The present disclosure provides a fishing device. The fishing device can be a lure fishing rod. Of course, the fishing device can also be of another type.

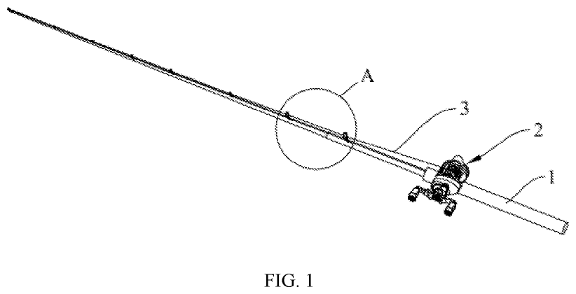

As shown in FIGS. 1 to 3, the fishing device includes a fishing rod 1, a reel 2, and a fishing line 3. The reel 2 is arranged at the fishing rod 1. The reel includes a spool 21 and a reel frame 22. The reel frame 22 is fixed at the fishing rod 1. The spool 21 is rotatably arranged at the reel frame 22. The fishing line 3 is wound around the spool 21.

In some embodiments, the reel 2 is arranged at the handle of the fishing rod 1 to facilitate the user to perform a casting operation and a retrieving operation on the fishing line. The reel 2 also includes a first guide member 23, and the fishing device further includes a second guide member 24. The first guide member 23 is arranged at the reel frame 22, and the second guide member 24 is arranged at the fishing rod 1. The first guide member 23 includes a first guide hole 231, and the second guide member 24 includes a second guide hole 241. The fishing line 3 passes through the first guide hole 231, then through the second guide hole 241, and extends to the end of the fishing rod 1. The bait is hung to the end of the fishing line 3.

When the user casts the bait into water, the fishing line 3 can be pulled out from the spool 21 by the bait. Before the bait falls into water, the spool 21 can remain in a free rotation state. After the bait is cast, the speed thereof can gradually increase. Before falling into water, the bait can reach its maximum speed. However, after the bait falls into water, the speed thereof can be rapidly reduced. Thus, the pulling away speed of the fishing line 3 can be rapidly reduced. Since the fishing line 3 being pulled out due to the rotation of the spool 21 cannot be pulled away by the bait in time, the spool 21 can reversely wind the cast fishing line 3 onto the spool 21 or cause the fishing line 3 to be loose and twisted, resulting in backlash of the real 2.

To address the above issue, the fishing device of embodiments of the present disclosure also includes a first detector, a second detector, and a control assembly. Moreover, a plurality of detection marks 31 are arranged along the axial direction of the fishing line 3 at intervals. The first detector can be configured to obtain the fishing line release speed by detecting the detection marks 31. The second detector can be configured to detect the rotation speed of the spool 21. The control assembly can be configured to control the brake assembly to brake the spool 21 according to the fishing line release speed obtained by the first detector to cause the rotation speed of the spool 21 to match the fishing line release speed of the fishing line 3.

When the user casts the bait, the first detector can obtain the fishing line release speed of the fishing line 3 and provide feedback to the control assembly. The control assembly can be configured to control the brake assembly to brake the spool 21 according to the detection result of the first detector. Moreover, the fishing device can be further configured to adjust the rotation speed of the spool 21 according to the fishing line release speed without shortening the casting distance of the fishing line 3. During the whole bait casting process, the control assembly can be configured to automatically complete the adjustment of the spool 21 without manual efforts, which improves the user experience.

In some embodiments, the fishing device can also include a brake assembly and a power supply. The brake assembly can be configured to apply resistance to brake the spool 21 to decelerate the spool 21. The power supply can be configured to supply power to a power-consuming module, such as the brake assembly, the first detector, and the second detector. The power supply can be a battery or another energy storage module. In some embodiments, the brake assembly can include a metal coil, and the spool 21 can include a permanent magnet. The metal coil can be connected to the power supply via a switch. When the metal coil is powered, the permanent magnet can rotate with the spool 21 and cut through the magnetic induction lines of the metal coil to generate magnetic resistance to further decelerate the spool 21.

When the control assembly receives the signal indicating the line release speed of the fishing line 3, the control assembly can control the brake assembly to apply the resistance to the spool 21 to cause the rotation speed of the spool 21 to match the line release speed of the fishing line 3 to prevent the real 2 from backlashing after the bait enters water. The fishing line 3 of embodiments of the present disclosure can be made of nylon, carbon, or polyethylene. Nylon line and carbon line are opaque, and polyethylene line has higher transparency with a refractive index close to water, making it suitable for fishing.

In some embodiments, the detection marks 31 on the fishing line 3 can have patterns of different shapes or contents. In some embodiments, the detection marks 31 can have coatings of different colors. The detection marks 31 on the fishing line 3 can have the same pattern or coating. The patterns can include special patterns, such as arrows, rings, tree textures, or numbers, to be recognized by the first detector. The coatings can be colored coatings, such as yellow coatings or blue coatings. In some embodiments, the detection marks 31 can include other feature information that is easy to recognize, which is not listed here.

Moreover, different patterns and/or different coatings can be distributed at the fishing line 3. That is, the plurality of detection marks 31 can include different patterns and/or coatings. Thus, the processing process of the detection marks 31 at the surface of the fishing line 3 can be simplified to reduce the processing difficulty of the detection marks 31.

In some embodiments, the plurality of detection marks 31 can be distributed either with an equal interval or non-equal intervals along the fishing line 3. When the detection marks 31 are distributed with the equal interval along the fishing line 3, the first detector can obtain the line release speed of the fishing line 3 by detecting the distance between two neighboring detection marks 31. Since the interval of any two detection marks 31 remains the same, the first detector can obtain the line release speed of the fishing line 3 through the distance between two consecutive detection marks 31 and the detection time interval. When the plurality of detection marks 31 are distributed along the fishing line 3 with the non-equal intervals, the first detector can obtain the line release speed of the fishing line 3 by detecting the reflection light or reflection wave of the detection marks 31.

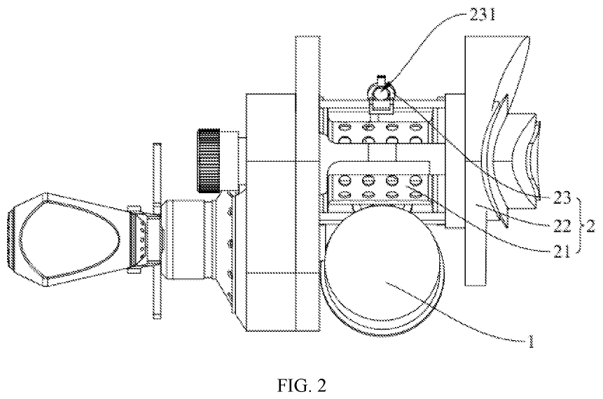

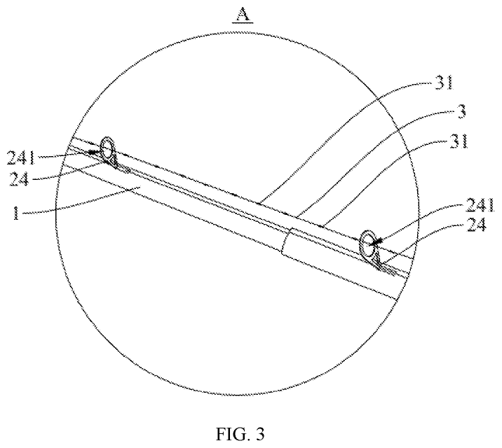

As shown in FIG. 2 and FIG. 3, one or more first detectors are provided and mounted at the same position on the fishing device. In some embodiments, when the fishing device includes one first detector, one first detector can be arranged at an inner wall of the first guide hole 231. The first detector can be configured to obtain the line release speed of the fishing line 3. When the fishing device includes the plurality of first detectors, the plurality of detectors can be arranged along the circumferential direction on the inner wall of the first guide hole 231 at intervals. A detection value of one of the first detectors can be used as the actual line release speed of the fishing line 3 to further improve the detection speed and accuracy. The first detector can be further arranged at the fishing rod 1, e.g., in a second guide hole 241. One first detector can be arranged at the inner wall of the second guide hole 241. In some other embodiments, the plurality of first detectors can be arranged along the circumferential direction on the inner wall of the second guide hole 241 at intervals, as long as the first detector can accurately determine the line release speed of the fishing line 3.

In some embodiments, when the plurality of detection marks 31 are distributed with non-equal intervals along the fishing line 3, the first detector can obtain the line release speed of the fishing line 3 by detecting the reflection light or reflection waves of the detection marks 31. The plurality of first detectors at the same position may need to be compared to obtain the accurate line release speed of the fishing line 3. Thus, the control assembly can include a comparator. The comparator can be configured to compare the reflection light of the detection marks 31 detected by the plurality of first detectors or the preset reflection light threshold or the preset reflection wave threshold corresponding to the reflection wave. The comparator can be further configured to select the line release speed of the fishing line 3 output by the first detector that detects that the reflection light has an intensity greater than the preset reflection light threshold or the detected reflection wave has an intensity greater than the preset reflection wave threshold as the actual line release speed.

In some embodiments, when the first detector is mounted at the first guide hole 231, a plurality of accommodation grooves can be formed along the circumferential direction of the inner wall. The depth of the first accommodation groove can be greater than the height of the first detector to embed the plurality of first detectors in the corresponding first accommodation grooves. The first detector can be stably fixed in the first guide hole through the first accommodation grooves. Meanwhile, the depths of the first accommodation grooves can be greater than the heights of the first detectors. Thus, the first detectors can be completely embedded in the corresponding first accommodation grooves to avoid contact or friction between the fishing line 3 and the first detector during casting. The first detectors can be better protected. The first detectors can be prevented from being contaminated by dust, impurities, or oil carried by the fishing line 3 to reduce the accuracy of the first detectors.

Similarly, when the first detectors are arranged in the second guide hole 241. A plurality of second accommodation grooves can be formed on the inner wall of the second guide hole 241 along the circumferential direction. The depth of the second accommodation groove can be greater than the height of the detector. Thus, the plurality of first detectors can be embedded in the corresponding second accommodation grooves. The first detectors can be stably mounted in the second guide hole 241 through the second accommodation grooves, and the depths of the second accommodation grooves can be greater than the heights of the first detectors. Thus, the first detectors can be fully embedded in the corresponding second accommodation grooves, which avoids the contact or friction between the fishing line 3 and the first detectors during casting. Thus, the protection for the first detectors can be improved, and the first detectors can be prevented from being contaminated by dust, impurities, or oil carried by the fishing line 3 to reduce the accuracy of the first detectors

In some embodiments, the first detector can be an optoelectronic detector. The optoelectronic detector can include at least one light emitter and at least one light receiver. The light emitter can be used as a light source to illuminate the surface of the fishing line 3, and the detection marks 31 on the surface of the fishing line 3 can reflect the light. The light receiver can receive the reflection light reflected by the detection marks 31. The detection marks 21 of the fishing line 3 can be randomly arranged. That is, the intervals between or types of the detection marks 31 can be different. When one detection mark 31 sends the reflection light to the light receiver at different time points, the optoelectronic detector can compare images at two different positions of the detection marks 31 of the fishing line 3 to obtain the real-time line release speed of the fishing line 3.

When the detection marks 31 on the fishing line 3 are periodically distributed, the optoelectronic detector can further include a pattern analysis unit. When two detection marks 31 on the surface of the fishing line 3 are detected consecutively, based on the time interval of the detection and the distance between the detection marks 31, the line release speed of the fishing line 3 can be obtained. For example, a material having a better reflection performance for light of a certain wavelength can be processed according to a certain pattern, shape, or color onto the fishing line 3. The light emitter can emit the light of the certain wavelength. When the light intensity of the reflection light of the certain wavelength received by the light receiver (a photosensitive element) can exceed a light intensity threshold, the first detector can be determined to detect the detection mark 31 on the fishing line 3 once. After the detection marks 31 on the fishing line 3 are detected twice consecutively, the line release speed of the fishing line 3 can be obtained.

The detection marks 31 can also reflect sound waves. The first detector can measure the actual line release speed of the fishing line 3 by emitting and receiving sound waves, which has a process having the same principle as the light wave detection and is not repeated any more.

To avoid noise caused by the inner wall of the first guide hole 231 reflecting the light or sound waves emitted by the first detector into the first detector, the inner wall of the first guide hole 231 can be coated with a light wave absorbing layer or a sound wave absorbing layer. The light wave absorbing layer can be set to absorb noise-free light waves, and the sound wave absorbing layer can be set to absorb noise-free sound waves.

In some embodiments, the detection mark 31 can include magnetic material, and the first detector can include a Hall sensor. The Hall sensor can detect the magnetic field strength of the detection mark 31 and determine that the detection mark 31 is detected when the magnetic field strength exceeds a preset magnetic field strength threshold. The detection marks 31 can be periodically distributed on the fishing line 3. The Hall sensor can obtain the line release speed of the fishing line 3 by consecutively detecting two detection marks 31.

In some embodiments, the Hall sensor can obtain the line release speed of the fishing line 3 based on the distance between the detection marks 31 (e.g., including magnetic material) and the time interval between the consecutive detections of the detection marks 31. Additionally, since the magnetic environment is relatively simple in a fishing scene, the noise introduced by the environment magnetic can be small. Thus, the Hall sensor can have relatively high precision in detecting the detection marks 31, and the detection precision and accuracy of the first detectors can be improved. In addition, the sensitivity of the Hall sensor can be adjusted by adjusting the magnetic field threshold of the Hall sensor to allow a plurality of magnetic materials to be used as the detection marks 21 distributed on the fishing line 3. Meanwhile, the Hall sensor may not be affected by the contaminations on the surface of the fishing line 3. The Hall sensor can have a high detection stability on the line release speed of the fishing line 3.

When the detection marks 31 are made of a magnetic material. The material can either be coated on the surface of the fishing line 3 or filled within the fishing line 3 to enrich the variety of the processing processes of the detection marks 31. The position of the magnetic material can be adaptively adjusted according to the manufacturing or user needs, and the types of the fishing line 3 can be enriched.

In addition, when the magnetic material is filled within the fishing line 3, the friction with the first guide member 23 and the second guide member 24 can be avoided. The wear degree of the detection marks 31 can be lowered, and the lifetime of the fishing line 3 can be extended.

In some embodiments, the plurality of first detectors can be arranged at different positions at the fishing rod 1 along the extension direction (the line release direction of the fishing line 3) of the fishing rod 1.

In some embodiments, at least two first detectors can be arranged at the reel 2 and/or the fishing rod 1 at an interval along the line release direction. Each detection mark 31 can include a special identifier that can be recognized by the first detector. In addition, at least one of different patterns or different coatings can be distributed on the fishing line 3 at an equal interval or non-equal interval to simplify the processing process of the detection mark 31 on the surface of the fishing line 3 and reduce the processing difficulty of the detection mark 31.

In some embodiments, the plurality of first detectors can be arranged at the real 2 or the fishing rod 1 at intervals, or the plurality of first detectors can be arranged at the real 2 and the fishing rod 1. To facilitate the mounting of the first detectors, the first detectors can be mounted in the first guide hole 231 of the first guide member 23 and the second guide hole 241 of the second guide member 24.

To facilitate description, for example, each of the real 2 and the fishing rod 1 can include one first detector. During the casting of the user, when a first speed detector on the real 2 detects a special detection mark 31 on the fishing line 3, a first timestamp can be recorded. When the first speed detector on the fishing rod 1 detects the special detection mark 31, a second timestamp can be recorded. Based on the time difference between the first timestamp and the second timestamp and the distance between the two first speed detectors, the line release speed of the fishing line 3 can be accurately obtained. The control assembly can control the brake assembly to brake the spool 21 according to the detection results of the two first detectors to cause the rotational speed of the spool 21 to match the line release speed of the fishing line 3. Thus, the backlash of the reel 2 can be avoided.

In embodiments of the present disclosure, the line release speed of the fishing line 3 can be obtained by detecting the same detection mark 31. The detection result can be more accurate compared to the detection result of using a single first speed detector. Since the distance between the two first detectors is a fixed value, an error factor affecting the instant line release speed of the fishing line 3 is only affected by the time difference between the first timestamp and the second timestamp. That is, the factor for generating the error can be reduced to a single factor. Thus, the calculated instant line release speed of the fishing line 3 can be more accurate.

In some embodiments, the distance between at least two first detectors can be adjustable. That is, the user can adjust the distance between the at least two first detectors according to the strength of bait casting. If the strength of bait casting is relatively large, the distance between the at least two first detectors can be adaptively increased to allow the at least two first detectors to sufficiently recognize the detection marks 31 on the fishing line 3 and increase the accuracy of the detection of the instant line release speed of the fishing line 3. If the strength of the bait casting is relatively small, the distance between the at least two first detectors can be adaptively reduced. By ensuring the detection stability of the first detector, the distance between the two first detectors can be ensured to be close to the instant line release speed (i.e., displacement per unit time) of the fishing line 3 as much as possible.

What is claimed is:

1. A fishing device comprising:
a fishing rod;
a reel arranged at the fishing rod and including a spool;
a fishing line wound around the spool and including a plurality of detection marks arranged along an axial direction of the fishing line at intervals;
a first detector configured to detect the detection marks to obtain a line release speed of the fishing line;
a second detector configured to detect a rotation speed of the spool; and
a control assembly configured to control a brake assembly to brake the spool according to the line release speed to cause the rotation speed of the spool to match the line release speed.

2. The fishing device according to claim 1, wherein:
the reel further includes:
a frame fixed at the fishing rod, the spool being rotatably arranged at the frame; and
a guide member arranged at the frame and including a guide hole, the fishing line passing through the guide hole; and
the first detector is one of a plurality of first detectors of the fishing device that are arranged at intervals at an inner wall of the guide hole and along a circumferential direction of the guide hole.

3. The fishing device according to claim 2, wherein:
a plurality of accommodation grooves are formed on the inner wall and along the circumferential direction of the guide hole;
the plurality of first detectors are embedded in the accommodation grooves, respectively, and
a depth of each of the plurality of accommodation grooves is greater than a height of a corresponding one of the plurality of first detectors.

4. The fishing device according to claim 2, wherein the inner wall of the guide hole is coated with a light-wave absorbing layer configured to absorb a light wave without noise.

5. The fishing device according to claim 2, wherein the inner wall of the guide hole is coated with a sound-wave absorbing layer configured to absorb a sound wave without noise.

6. The fishing device according to claim 2, wherein the control assembly includes a comparator configured to:
compare reflection lights from the plurality of detection marks detected by the plurality of first detectors with a preset reflection light threshold; and
select a line release speed of the fishing line output by one first detector of the plurality of first detectors as an actual line release speed, the reflection light detected by the one first detector having an intensity greater than the preset reflection light threshold.

7. The fishing device according to claim 2, wherein the control assembly includes a comparator configured to:
compare reflection waves from the plurality of detection marks detected by the plurality of first detectors with a preset reflection wave threshold; and
select a line release speed of the fishing line output by one first detector of the plurality of first detectors as an actual line release speed, the reflection wave detected by the one first detector having an intensity greater than the preset reflection wave threshold.

8. The fishing device according to claim 1, further comprising:
a guide member arranged at the fishing rod and including a guide hole;
wherein:
the fishing line passes through the guide hole and extends out of an end of the fishing rod; and
the first detector is one of a plurality of first detectors arranged at intervals at an inner wall of the guide hole and along a circumferential direction of the guide hole.

9. The fishing device according to claim 8, wherein:
a plurality of accommodation grooves are formed on the inner wall and along the circumferential direction of the guide hole;
the plurality of first detectors are embedded in the accommodation grooves, respectively, and
a depth of each of the plurality of accommodation grooves is greater than a height of a corresponding one of the plurality of first detectors.

10. The fishing device according to claim 8, wherein the inner wall of the guide hole is coated with a light-wave absorbing layer configured to absorb a light wave without noise.

11. The fishing device according to claim 8, wherein the inner wall of the guide hole is coated with a sound-wave absorbing layer configured to absorb a sound wave without noise.

12. The fishing device according to claim 1, wherein:
the plurality of detection marks are arranged along the fishing line with an equal interval; and
the first detector is configured to obtain the line release speed of the fishing line by detecting the interval between two neighboring detection marks.

13. The fishing device according to claim 12, wherein the detection marks include patterns of different shapes or contents that are randomly distributed along the fishing line.

14. The fishing device according to claim 12, wherein the detection marks include coatings of different colors that are randomly distributed along the fishing line.

15. The fishing device according to claim 1, wherein:
the plurality of detection marks are arranged at the fishing line with non-equal intervals; and
the first detector is configured to obtain the line release speed of the fishing line by detecting reflection light or reflection waves of the detection marks.

16. The fishing device according to claim 1, wherein:
the detection mark includes a magnetic material, and the first detector includes a Hall sensor configured to detect a magnetic field strength of the detection marks and determine that a detection mark is detected in response to the magnetic field strength exceeding a preset magnetic field strength threshold; and
the Hall sensor is configured to obtain the line release speed of the fishing line by consecutively detecting two detection marks.

17. The fishing device according to claim 16, wherein the magnetic material is coated on a surface of the fishing line.

18. The fishing device according to claim 16, wherein the magnetic material is filled within the fishing line.

19. The fishing device according to claim 1, wherein:
the first detector is one of at least two first detectors arranged at the real at intervals along a line release direction of the fishing line; and
each of the detection marks includes a special identifier recognizable by the first detector.

20. The fishing device according to claim 1, wherein:
the first detector is one of at least two first detectors arranged at the fishing rod at intervals along a line release direction of the fishing line; and
each of the detection marks includes a special identifier recognizable by the first detector.
